(19) United States
(12) Patent Application Publication
(10) Pub. No.: US 2026/0097533 A1
(43) Pub. Date: Apr. 9, 2026

(54) Cutting device for capsules

(71) Applicant: SACMI COOPERATIVA MECCANICI IMOLA SOCIETA’ COOPERATIVA, Imola (BO) (IT)

(72) Inventors: Matteo VENTURINI, Imola (BO) (IT); Davide PENAZZI, Imola (BO) (IT)

(21) Appl. No.: 19/340,779

(22) Filed: Sep. 25, 2025

(30) Foreign Application Priority Data
Oct. 3, 2024 (IT) 102024000021897

(51) Int. Cl. B26D 1/03; B26D 1/00; B26F 1/44; B65D 41/32; B65D 55/16

(52) U.S. Cl. CPC B26D 1/03; B26D 1/0006; B26F 1/44; B65D 41/32; B65D 55/16; B26D 2001/0033; B26D 2001/0053; B26F 2210/04; B65D 2401/15

(57) ABSTRACT

A device for cutting a capsule of tethered type for closing a container is disclosed, in which the cutting device comprises a first set of horizontal blades that are coplanar with each other, a second set of horizontal blades that are coplanar with each other and spaced vertically apart from the horizontal blades of the first set, and a set of transverse blades arranged for joining together the horizontal blades so as to make two connecting straps between a tamper-evident band and a side wall of the capsule, in addition to another transverse blade that on one side terminates in an intermediate point of one of the horizontal blades and on the opposite side terminates in a free point, i.e. not adjacent to any blade, so that a transverse notch made by this other transverse blade ends with an end completely surrounded by a portion of capsules that is not destined to be broken.

### BACKGROUND OF THE INVENTION

The invention relates to a cutting device for cutting capsules or caps, for example capsules or caps made of plastics, of the type used for closing containers like, for example, bottles. In particular, the invention relates to a device for making cuts or notches for making the aforesaid tethered capsules, i.e. capsules that remain tethered to the container even after opening thereof.

The invention further relates to a cutting apparatus that is suitable for cutting capsules and is provided with the cutting device in question.

In particular, reference is made to a cutting device made according to the preamble of the first claim. Such a cutting device is known from patent publication US 2022/0126472 A1.

Patent publication US 2022/0126472 A1 shows a cutting device featuring a tooth portion on the main body of the capsule and a corresponding recess on the tamper-evident band. The tooth portion is situated between the intended separating line of the tamper-evident band and a strap that connects the tamper-evident band to the main body of the capsule. The tooth portion is obtained by two tilted cutting edges joined by a corresponding horizontal edge. Owing to the arrangement and the conformation of the tooth portion, the strap near the portion behaves more elastically in use and is therefore more sensitive to breakage.

Certain aspects of the prior art are improvable.

Firstly, it has been seen that the tooth portion made by the cutting device shown by patent publication US 2022/0126472 A1 can cause a certain difficulty or inconvenience for the user, representing an obstacle or an annoyance during mixing of the drink, or when the container is brought to the mouth to drink directly from the container, both during the step of reclosing the container after the first opening with breakage of the breakable security device.

Secondly, it is desirable to simplify the structure of the cutting device and make notches on the capsules always precisely and repeatedly.

Further, it is desirable to further reduce the risk of breakage of a connecting strap between the tamper-evident band and the rest of the capsule, maintaining at the same time the possibility of easy and comfortable use for the user of the capsule, both in the steps of opening and reclosing the capsule, and in the step of mixing the beverage contained in the container associated with the closing capsule.

### SUMMARY OF THE INVENTION

One object of the invention is to improve cutting apparatuses and devices of known type used for cutting closing capsules for closing containers.

One object is to make an apparatus and/or a device that is able to overcome one or more of the aforesaid limits and drawbacks of the prior art.

One object is to provide an apparatus and/or a device for cutting capsules that are alternative to those of the prior art.

One advantage is to provide a cutting device that is able to make notches on the capsules in a precise and repeatable manner.

One advantage is to procure a cutting device that is suitable for producing capsules with one or more straps for connecting between a tamper-evident band and the rest of the capsule in which the risk of breaking of the connecting strap is reduced.

One advantage is to enable the user to use the capsule easily and comfortably, both in the steps of opening and reclosing the capsule and in the step of mixing the beverage contained in the container associated with the closing capsule.

One advantage is to improve the cutting quality of the transverse (i.e. vertical or oblique) blades used, in particular, to produce tethered capsules.

One advantage of the invention is to ensure correct execution of the horizontal and transverse cuts made in the capsules.

One advantage is to make a cutting device available that is suitable for cutting capsules and is constructionally simple and cheap.

Such objects and advantages, and still others, are achieved by a cutting device according to one or more of the claims set out below.

In one embodiment, a cutting device comprises two sets of horizontal blades, spaced vertically apart from one another, and two or more transverse blades arranged for joining together the horizontal blades so as to make one or more connecting straps to connect together a tamper-evident band and a side wall of a capsule, in which the cutting device further comprises a special transverse blade that on one side ends in an intermediate point of a horizontal blade and on the opposite side ends with a free end, i.e. that is not adjacent to any other blade, so that a transverse notch made by the special transverse blade ends with a closed end completely surrounded by a portion of capsules that is not destined to be broken.

The cutting device may be included, in particular, in a cutting apparatus that comprises a carousel equipped with a plurality of conveying units each configured to engage the capsule and convey the capsule to the cutting device.

### BRIEF DESCRIPTION OF THE DRAWINGS

The invention can be better understood and implemented with reference to the attached drawings, which illustrate embodiments thereof by way of non-limiting example, in which:

FIG. 1 is a perspective view of an embodiment of a cutting device made in accordance with the present invention, in which a capsule and a capsule feed path are shown schematically;

FIG. 2 shows an enlarged detail of FIG. 1;

FIG. 3 is a top plan view of the cutting device of FIG. 1;

FIG. 4 is an exploded view of the layered structure of the cutting device of FIG. 1 in which the three plates that make up the layered structure are visible;

FIG. 5 shows an enlarged detail of FIG. 4;

FIG. 6 is another exploded view of the cutting device of FIG. 1 from a different perspective from the exploded view of FIG. 4;

FIG. 7 is a top plan view of the third plate that forms the intermediate layer of the layered structure of the cutting device of FIG. 1;

FIG. 8 shows an enlarged detail of the third plate of FIG. 7;

FIG. 9 shows an enlarged detail of FIG. 4 in which the modular insert is visible that forms the fifth transverse blade and includes the cutting element provided with the transverse cutting edge and the interchangeable gauge block coupled with the cutting element;

FIG. 10 shows a perspective view of the modular insert of FIG. 9 and of the components of the insert, i.e. a view of the cutting element and a view of the interchangeable gauge block;

FIG. 11 shows three top plan views of three interchangeable gauge blocks that can be selectively coupled with the same cutting element to modify the cutting depth;

FIG. 12 is a flat extent of the notches obtained on the side wall of the capsule by the cutting device of FIG. 1;

FIGS. 13, 14 and 15 show a capsule obtained by the cutting device of FIG. 1 in different side views;

FIG. 16 is a perspective view of the capsules of FIGS. 13, 14 and 15;

FIG. 17 is a side view of the capsule of FIG. 16 in a configuration adopted during the step of opening the capsule;

FIG. 18 is a top view of the capsule of FIG. 17 in an open configuration of the container with the capsule overturned and connected to the container;

FIG. 19 is a perspective view of the capsule in the open configuration of FIG. 18 with the capsule overturned and connected to the container;

FIG. 20 shows a capsule obtained by a cutting device that is not illustrated that differs from the device of FIG. 1 mainly by the fact that the fifth transverse blade is oblique rather than vertical and as a result the corresponding notch made in the capsule is oblique rather than vertical;

FIG. 21 is a plan view of a cutting apparatus for cutting capsules showing a spindle support carousel, conveying spindles and a cutting zone in which the cutting device of FIG. 1 is arranged;

FIG. 22 is a perspective view of a second device of a cutting device made in accordance with the present invention;

FIG. 23 shows an enlarged detail of FIG. 22.

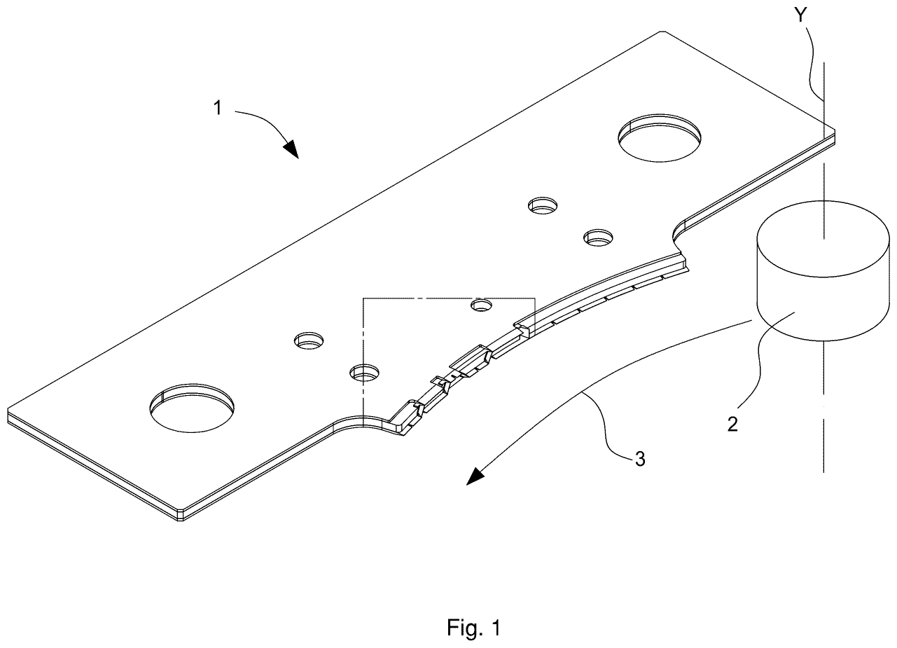

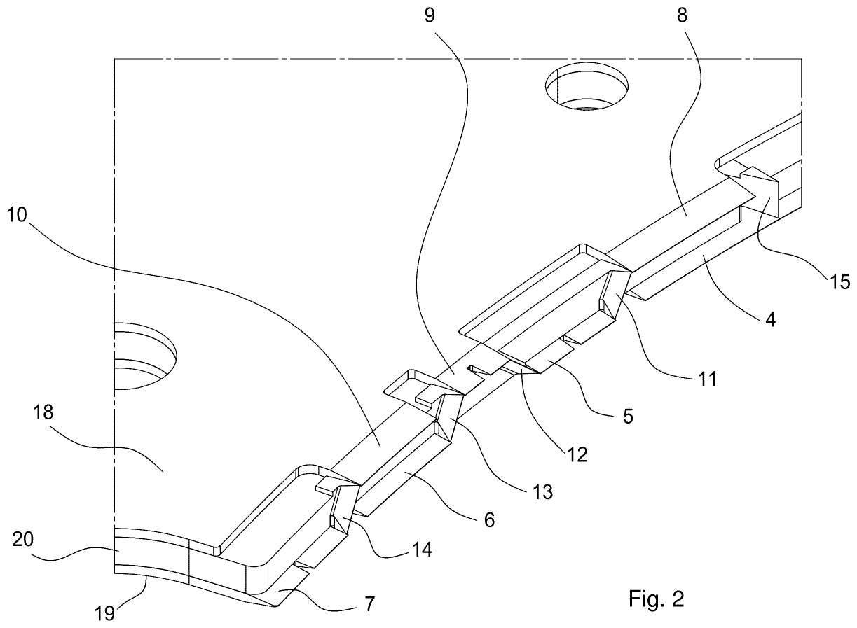

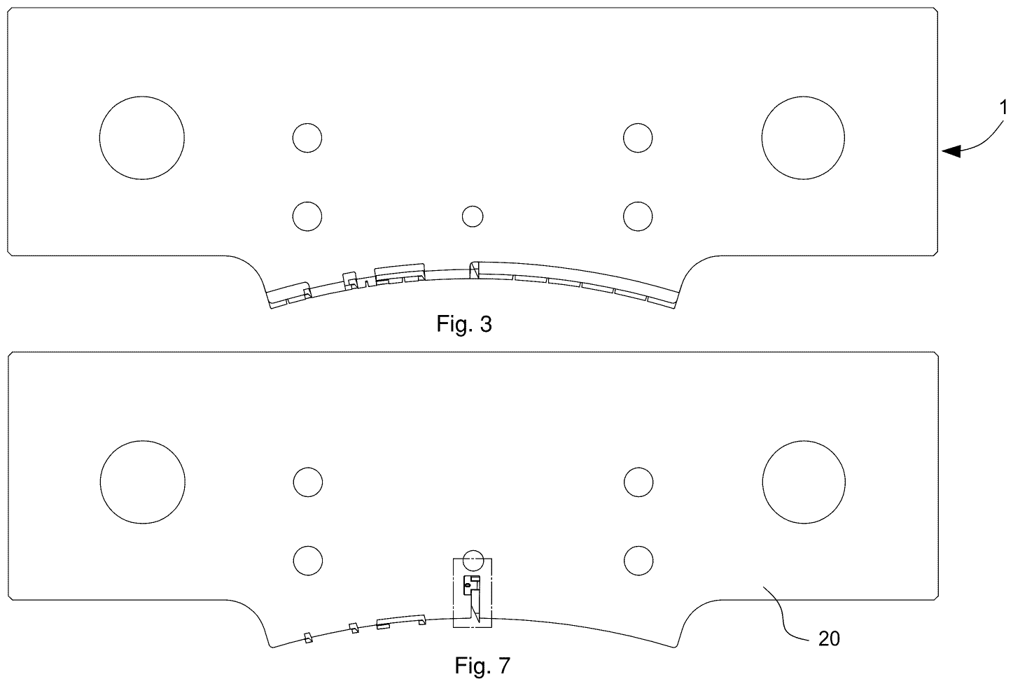

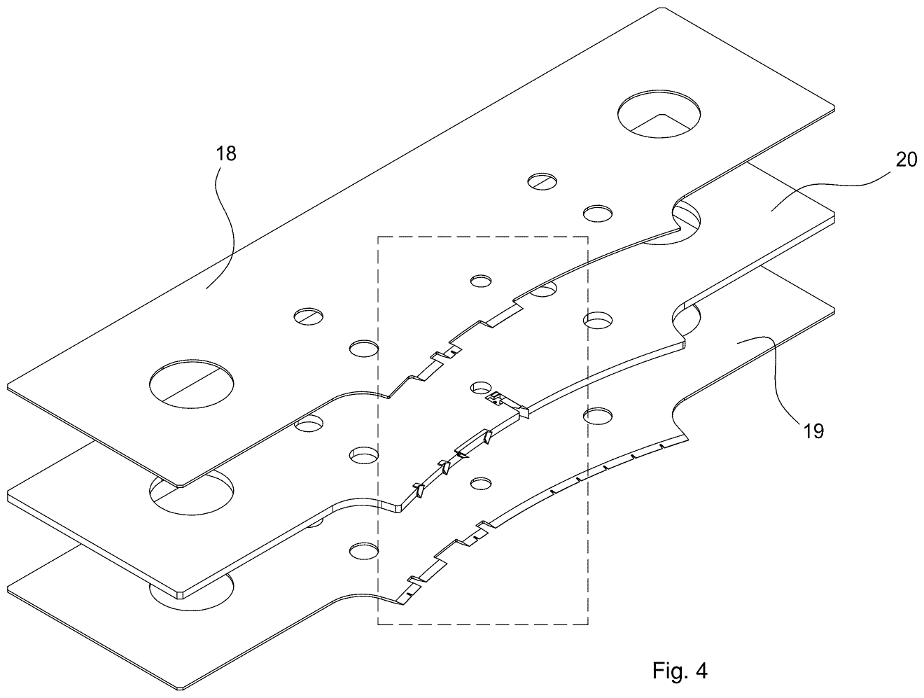

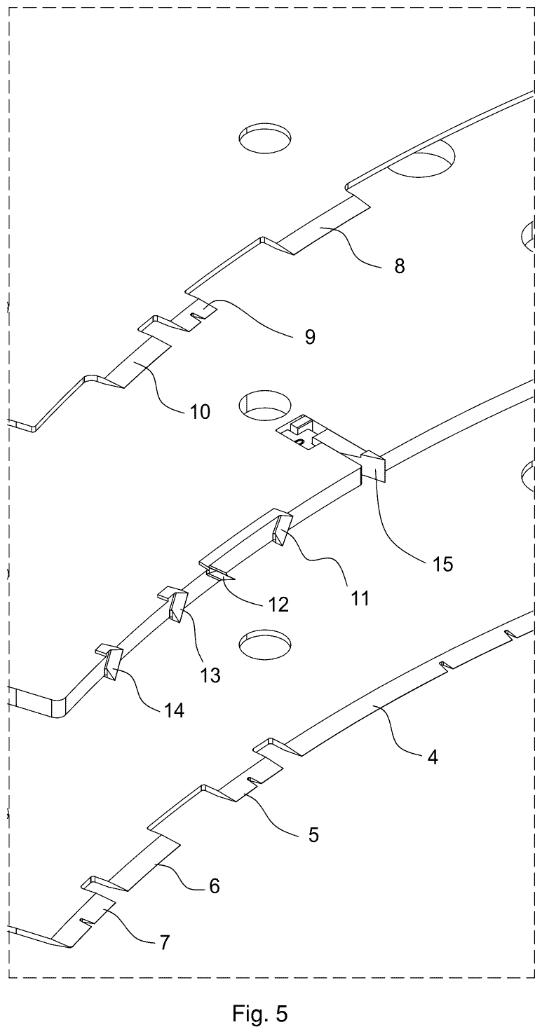

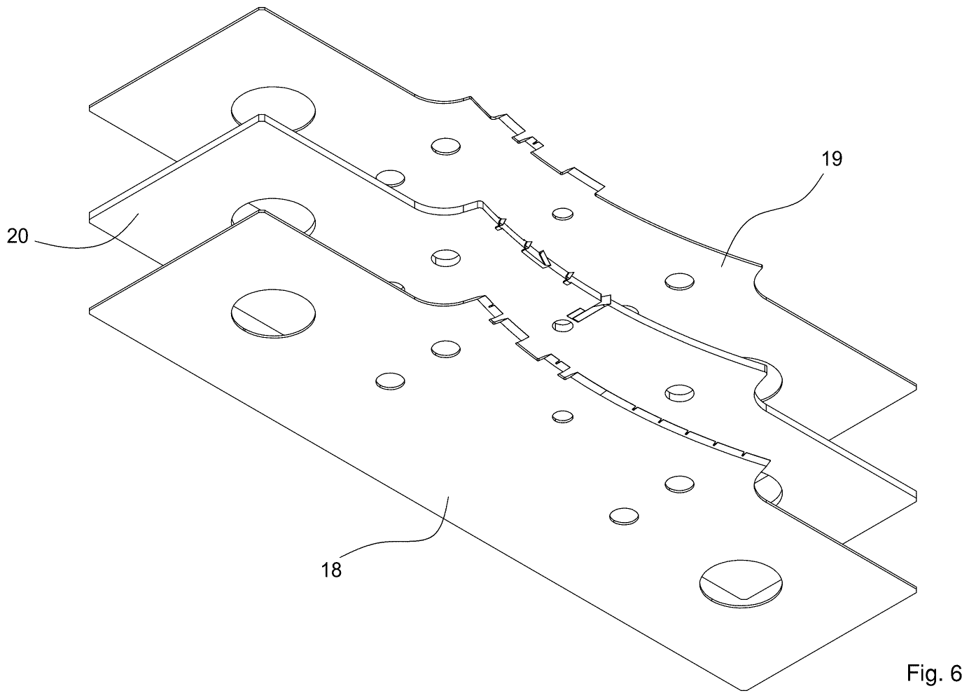

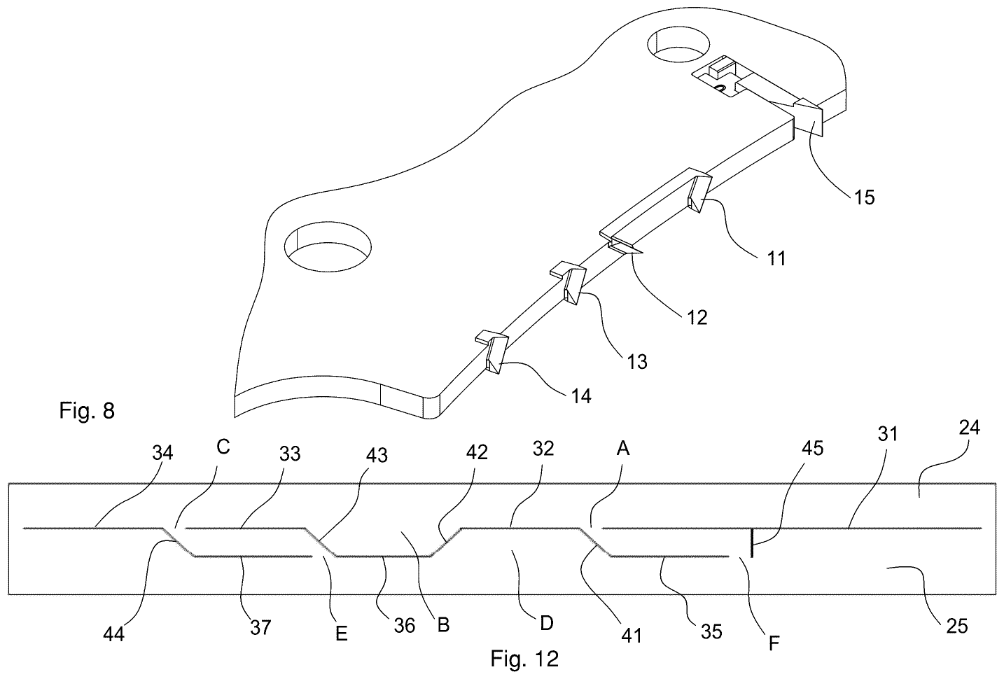

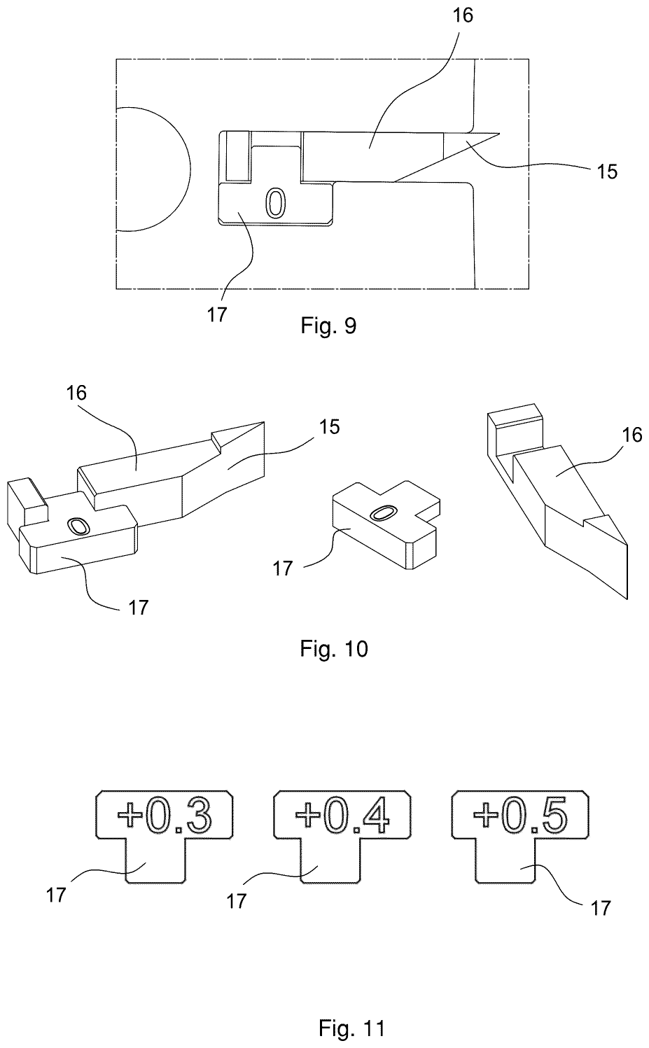

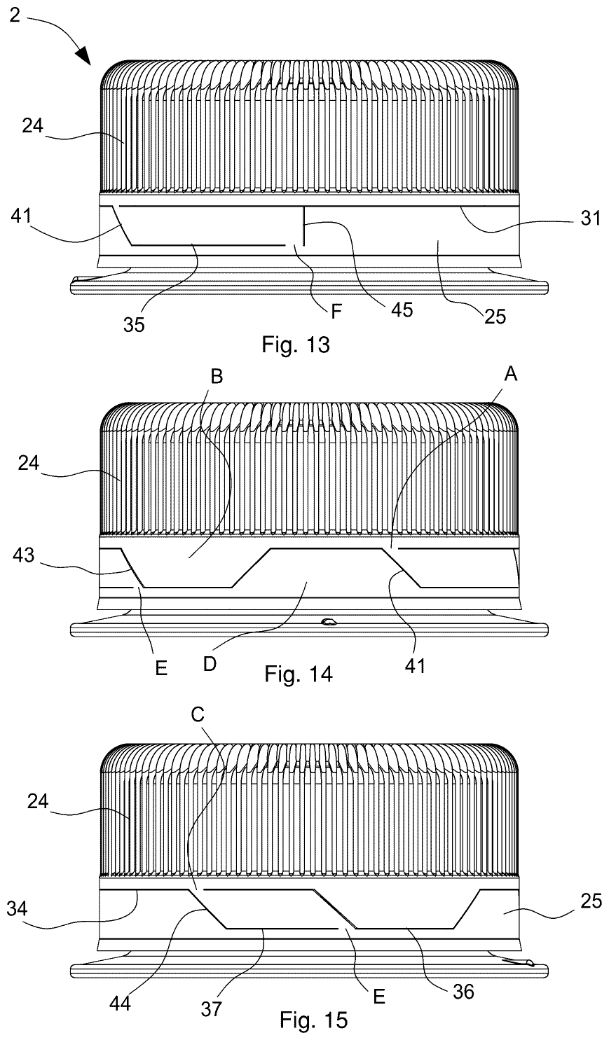

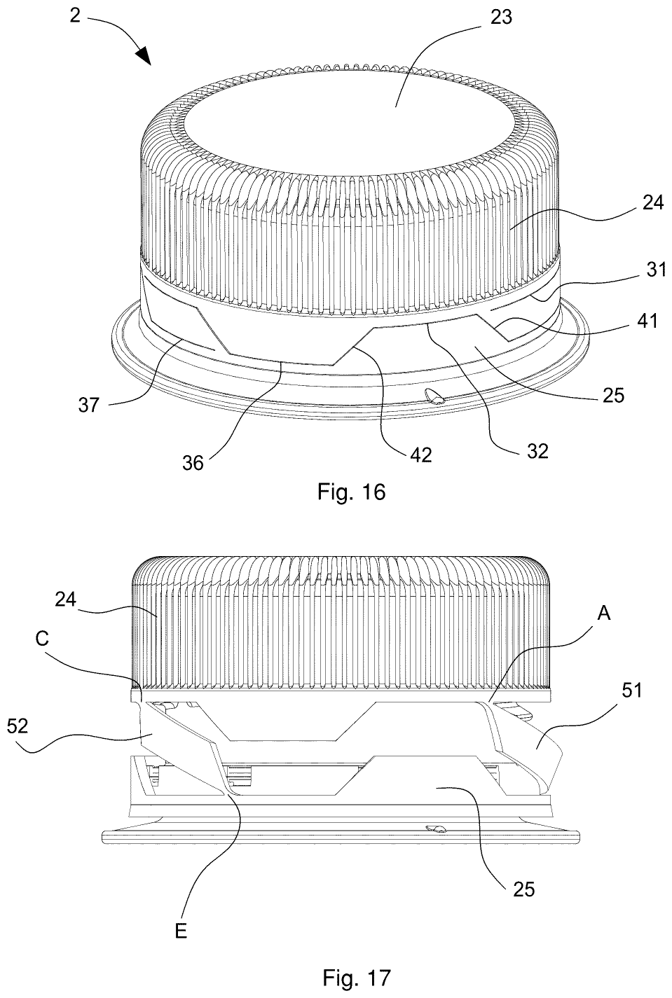

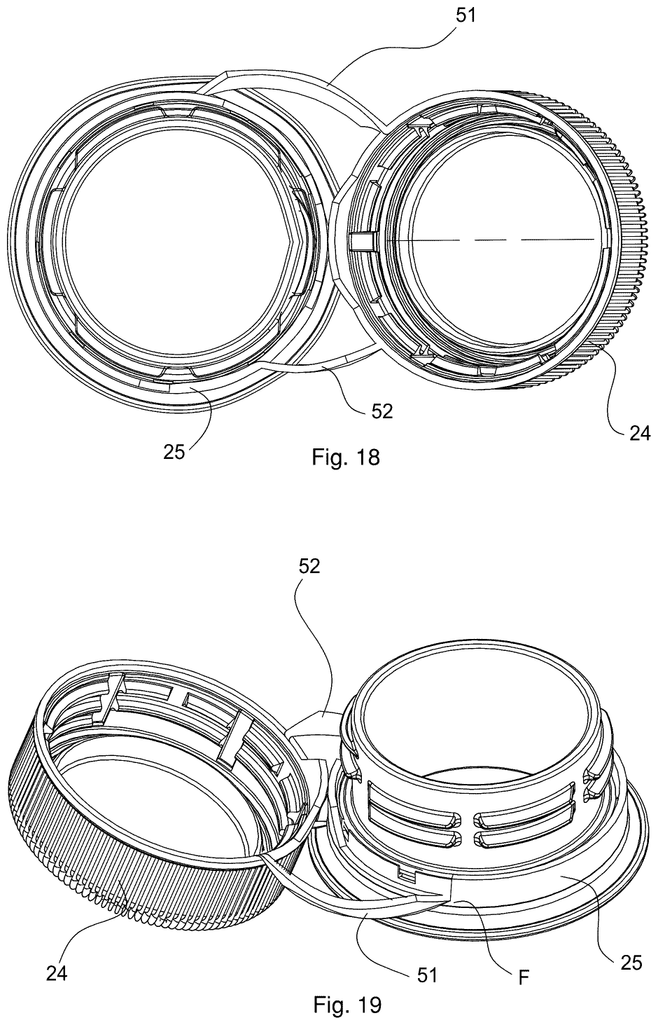

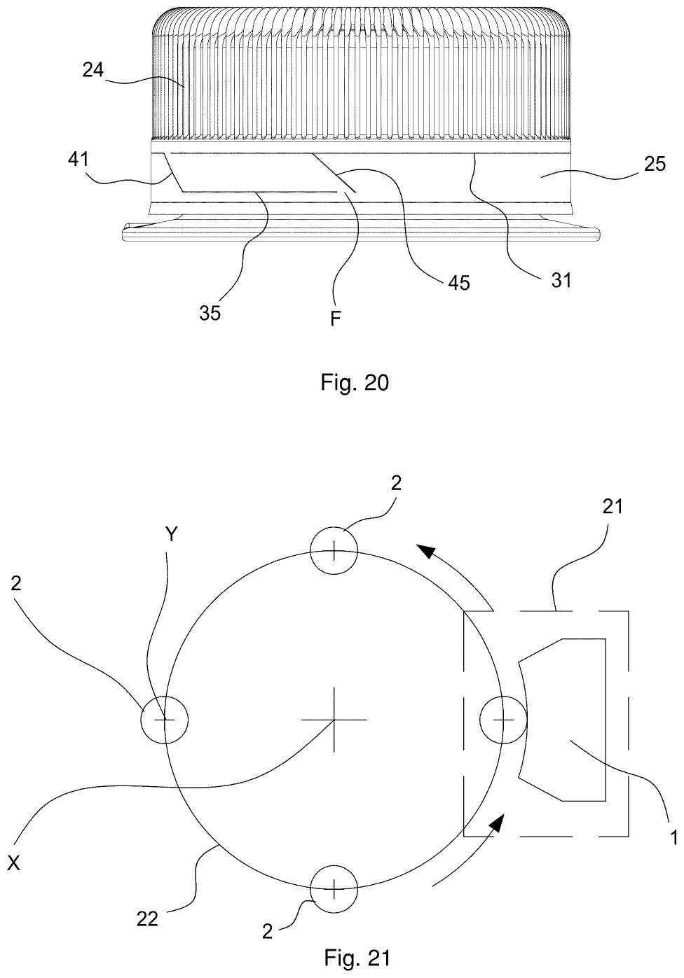

### DETAILED DESCRIPTION

With reference to the figures mentioned above, 1 indicates a cutting device arranged for cutting a capsule 2 (or cap). The capsule 2 may be made, in particular, of plastics. In use, the capsule 2 rolls on a cutting portion of the cutting device 1 in an advancement direction. The capsules 2 are usable, in particular, to close containers, for example bottles.

The cutting device 1 comprises horizontal blades and transverse blades. “Horizontal” blade means that the blade is arranged substantially parallel to the direction of advancement 3 (which is in fact generally horizontal) with which the capsule 2 is fed to the cutting device 1, which is fixed. “Transverse” blade means that the blade is transverse to the aforesaid advancement or feeding direction 3 of the capsule 2. In practice, transverse can mean oblique (or tilted) or vertical.

The cutting device 1 comprises a first set of horizontal blades, a second set of horizontal blades and a set of transverse blades.

Each horizontal blade of the first set of horizontal blades is spaced vertically apart from each horizontal blade of the second set of horizontal blades.

The first set of horizontal blades comprises a first horizontal blade 4, a second horizontal blade 5, a third horizontal blade 6 and a fourth horizontal blade 7. The blades 4, 5, 6 and 7 of the first set of horizontal blades are arranged in sequence next to one another and spaced apart from one another along the direction of advancement 3 of the capsule (i.e. in a horizontal and circumferential direction).

The first horizontal blade 4 is configured to make a horizontal notch with several easy-to-break attachment points so as to define a weakening line of the tamper-evident band of the container closure capsule 2.

The second horizontal blade 5 is spaced apart in a horizontal direction (along the direction of advancement 3 of the capsule) from the first horizontal blade 4 with the interposition of a first non-cutting zone at which a first joint portion A will be formed. A joint portion is the part of a connecting strap that is not destined to be broken and thus enables the tamper-evident band to remain attached to the capsule even after opening.

The third horizontal blade 6 is spaced apart in a horizontal direction (along the direction of advancement 3 of the capsule) from the second horizontal blade 5 with the interposition of a second non-cutting zone at which at which a portion B will be formed that is not destined to be broken (arranged on the side of the side wall of the capsule) and not being part of a joint portion of a connecting strap.

The fourth horizontal blade 7 is spaced apart in a horizontal direction (along the direction of advancement 3 of the capsule) from the third horizontal blade 6 with the interposition of a third non-cutting zone at which a second joint portion C will be formed.

The second set of horizontal blades comprises a fifth horizontal blade 8, a sixth horizontal blade 9 and a seventh horizontal blade 10. The blades 8, 9 and 10 of the second set of horizontal blades are arranged in sequence next to one another and spaced apart from one another along the direction of advancement 3 of the capsule (i.e. in a horizontal and circumferential direction).

It is possible, as in this specific embodiment, that in the assembled use configuration of the cutting device 1, at least one portion of the insert fifth horizontal blade 8 is arranged in a vertical direction at a portion of the first horizontal blade 4.

The sixth horizontal blade 9 is spaced apart in a horizontal direction from the fifth horizontal blade 8 with the interposition of a fourth non-cutting zone at which another portion D will be formed that is not destined to be broken (arranged on the side of the tamper-evident band of the capsule opposite the side of the side wall) and not being part of a joint portion of a connecting strap.

The seventh horizontal blade 10 is spaced apart in a horizontal direction from the sixth horizontal blade 9 with the interposition of a fifth non-cutting zone at which a third joint portion E will be formed.

The set of transverse blades comprises a first transverse blade 11, a second transverse blade 12, a third transverse blade 13, a fourth transverse blade 14 and a fifth transverse blade 15.

The first transverse blade 11 joins together the second horizontal blade 5 and the fifth horizontal blade 8. The second transverse blade 12 joins together the second horizontal blade 5 and the sixth horizontal blade 9. The third transverse blade 13 joins together the third horizontal blade 6 and the sixth horizontal blade 9. The fourth transverse blade 14 joins together the fourth horizontal blade 7 and the seventh horizontal blade 10.

The fifth transverse blade 15 ends on one side with a first end joined to the first horizontal blade 4 and on the opposite side ends with a second end (opposite the first end) spaced apart in a horizontal direction from the fifth horizontal blade 8 with the interposition of a sixth non-cutting zone at which a fourth joint portion F will be formed.

The fifth transverse blade 15 is joined to the first horizontal blade 4 in an intermediate point of the first horizontal blade 4 such that a transverse notch made by the fifth transverse blade 15 meets the horizontal notch made by the first horizontal blade 4 in an intermediate point of the aforesaid horizontal notch (forming in the zone of the aforesaid intermediate point a T-shaped notch).

The aforesaid second end of the fifth transverse blade 15 is free, or open, i.e. shaped and arranged in such a manner that the transverse notch made by the fifth transverse blade 15 at which the second end terminates with a blind or closed notch end, i.e. terminates completely surrounded by a portion of material of the capsule, in particular by a portion of material that is not destined to be broken.

As in this embodiment, it is possible for the horizontal blades 4, 5, 6 and 7 of the first set of horizontal blades to have cutting edges that are coplanar with each other (arranged on a horizontal plane). It is possible, as in this embodiment, for the horizontal blades 8, 9 and 10 of the second set of horizontal blades to have cutting edges that are coplanar with each other (arranged on a horizontal plane).

It is possible, as in this embodiment, for the aforesaid second (blind) end of the fifth transverse blade 15 to be situated at a horizontal plane passing through a horizontal cutting edge of the fifth horizontal blade 8. The fifth transverse blade 15 may be, in particular, vertical. It is possible, in embodiments that are not illustrated, for the fifth transverse blade 15 to be oblique.

At least one portion of the seventh horizontal blade 10 may be, in particular (as in the illustrated embodiment), arranged in a vertical direction at a portion of the third horizontal blade 6.

The fifth transverse blade 15 may comprise, in particular (as in the illustrated embodiment), a modular insert consisting of a cutting element 16 and of a gauge block 17. The cutting element 16 is provided at one end with a transverse cutting edge. The aforesaid cutting element 16 is inserted into a seat of the cutting device 1 and is coupled with the interchangeable gauge block 17 so as to determine precisely a length between the transverse cutting edge and an abutment face of the gauge block 17. The abutment face is arranged against a bottom wall of the aforesaid seat of the insert.

One end of the aforesaid cutting element 16, opposite the transverse cutting edge, is spaced apart from the aforesaid bottom wall.

Using an insert consisting of a cutting element with a transverse cutting and of a set of interchangeable gauge blocks for modifying a cutting depth of the transverse blade is known from patent publication US 2023/0241793 A1, which it is understood to incorporate by reference.

Also in this case, a set of two, three, four or more interchangeable gauge blocks 17 is used that are selectively couplable with the aforesaid element to determine two or more different lengths between the transverse cutting edge and an abutment face of the respective gauge block.

It is possible for the first transverse blade 11 to be oblique and/or the second transverse blade 12 to be oblique and/or the third transverse blade 13 to be oblique and/or the fourth transverse blade 14 to be oblique. In this specific embodiment, the first transverse blade 11, the second transverse blade 12, the third transverse blade 13 and the fourth transverse blade 14 are all four oblique.

In particular, it is possible for the first transverse blade 11, the third transverse blade 13 and the fourth transverse blade 14 to be tilted in the same direction and for the second transverse blade 12 to be tilted in the opposite direction.

At least one of the second horizontal blade 5, the third horizontal blade 6 and the fourth horizontal blade 7 may be configured, in particular, to make a horizontal notch with at least one easy-to-break attachment point.

At least one of the fifth horizontal blade 8, the sixth horizontal blade 9 and the seventh horizontal blade 10 may be, in particular, configured to make a horizontal notch with at least one easy-to-break attachment point. In this specific embodiment, the second horizontal blade 5, the fourth horizontal blade 7 and the sixth horizontal blade 9 are configured to make a horizontal notch with at least one easy-to-break attachment point, whereas the third horizontal blade 6, the fifth horizontal blade 8 and the seventh horizontal blade 10 are configured to make a continuous horizontal notch without any easy-to-break attachment point.

The fifth transverse blade 15 may comprise, in particular, a continuous transverse cutting edge configured to make a transverse notch without any easy-to-break attachment point. The fifth transverse blade 15 may comprise, in particular, a (continuous) vertical cutting edge.

The first horizontal blade 4 may end, in particular, with a proximal end which is close to the second horizontal blade 5 and which is contiguous to the aforesaid first non-cutting zone of the cutting device 1. The first horizontal blade 4 may have, in particular, a portion of continuous horizontal cutting edge that extends between the aforesaid proximal end and the aforesaid intermediate point of meeting with the fifth transverse blade 15. The aforesaid portion of continuous horizontal cutting edge of the first horizontal blade 4 may be configured, in particular, to make a portion of continuous horizontal notch without any easy-to-break attachment point.

The cutting device 1 may comprise, as in the illustrated embodiment, a layered structure with at least three plates that are fixed in a pack on one another (for example by locking means of known type) and which comprise a first plate 18 that carries the first set of horizontal blades, a second plate 19 that carries the second set of horizontal blades and a third plate 20 that carries the set of transverse blades and is interposed between the first plate 18 and the second plate 19.

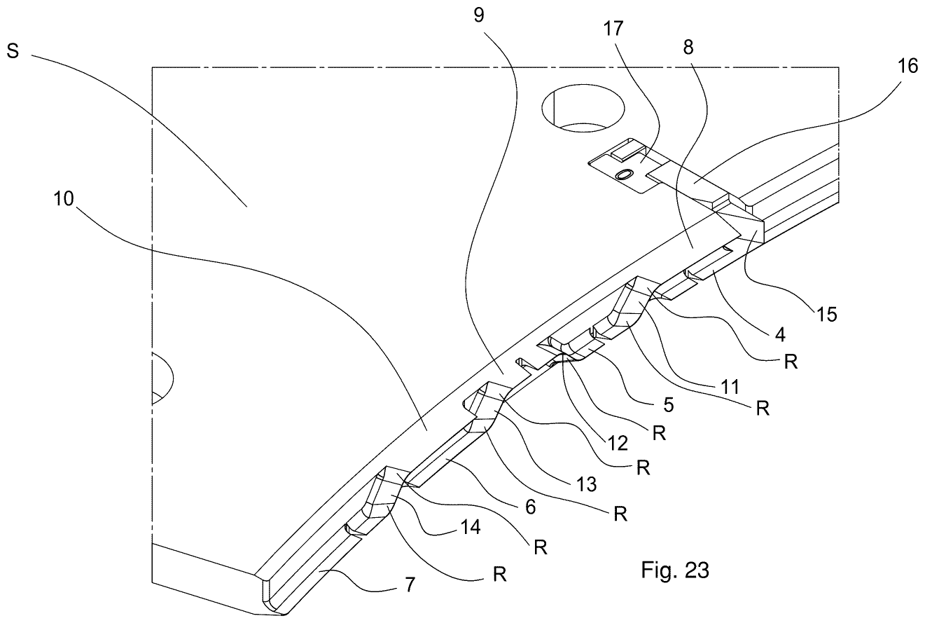

In other embodiments (like the embodiment shown in FIGS. 22 and 23) it is also possible for the first set of horizontal blades, the second set of horizontal blades and the set of transverse blades (except possibly the fifth transverse blade 15) to be integrated in a single piece S. In these embodiments, it is also possible for at least one of the first, the second, the third and the fourth transverse blade to be joined to at least one of the aforesaid horizontal blades by a rounded portion R of cutting edge.

In the specific embodiment of FIGS. 22 and 23, the fifth transverse blade 15 comprises the cutting element 16 equipped with the transverse cutting edge and inserted into a seat of the single piece S into which the other blades are integrated. The cutting element 16 is further coupled with the interchangeable gauge block 17.

In particular, it is possible for the first transverse blade 11 to be joined to the second horizontal blade 5 by a rounded portion R of cutting edge and/or for the first transverse blade 11 to be joined to the fifth horizontal blade 8 by a rounded portion R of cutting edge and/or for the second transverse blade 12 to be joined to the second horizontal blade 5 by a rounded portion R of cutting edge and/or for the second transverse blade 12 to be joined to the sixth horizontal blade 9 by a rounded portion R of cutting edge and/or for the third transverse blade 13 to be joined to the third horizontal blade 6 by a rounded portion R of cutting edge and/or for the third transverse blade 13 to be joined to the sixth horizontal blade 9 by a rounded portion R of cutting edge and/or for the fourth transverse blade 14 to be joined to the fourth horizontal blade 7 by a rounded portion R of cutting edge and/or for the fourth transverse blade 14 to be joined to the seventh horizontal blade 10 by a rounded portion R of cutting edge. In the specific embodiment of FIGS. 22 and 23, rounded portions R of cutting edge are arranged at the two opposite ends of each of the transverse blades 11, 12, 13 and 14.

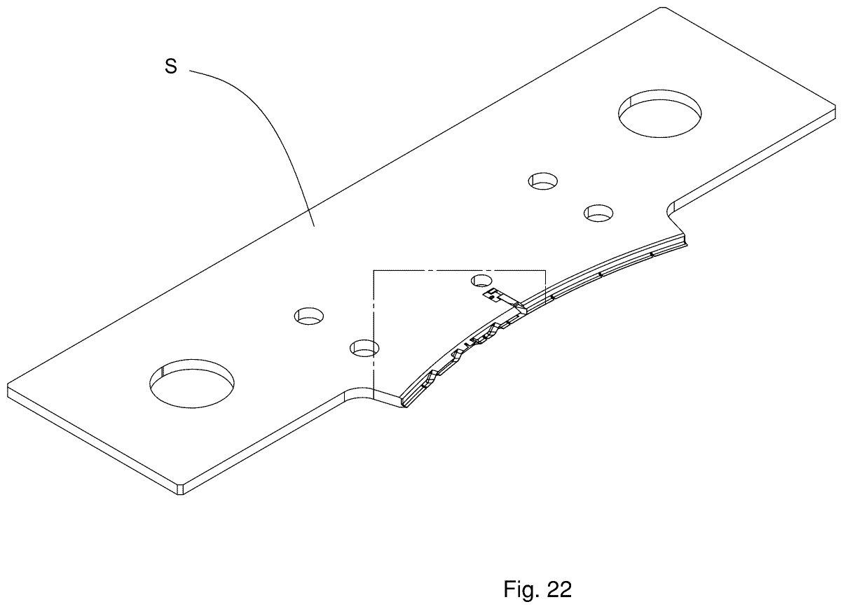

FIG. 21 shows a cutting apparatus comprising an advancement path that is followable by a capsule 2, a cutting zone 21 arranged in the advancement path, and a carousel 22 provided with a plurality of conveying units each of which is configured to engage a respective capsule 2 and to convey the capsule along the advancement path. The carousel 22 is able to rotate upon command around a (vertical) rotation axis X. Each conveying unit may comprise, in particular, an engaging member (for example a spindle) that is rotatable around a (vertical) Y axis carried by the carousel 22 to control a rotation of the capsule 2 on itself during rolling of the capsule 2 on the cutting device 1. The cutting apparatus comprises the cutting device 1 arranged in the cutting zone 21 to cut the capsule.

The cutting device 1 is usable for making the “tethered” capsule for closing a container. The capsule 2 may comprise, in particular, a cup body with a closing wall 23 that defines a closed end of the cup body. The closing wall 23 may be, in particular, disc-shaped. The cup body may comprise, in particular, a side wall 24 that is contiguous with the closing wall 23 and that extends from a periphery of the closing wall 23 around a longitudinal axis of the capsule 2. The side wall 24 is provided with an (upper) end joined to the periphery of the closing wall 23. The side wall 24 may be, in particular, a cylindrical side wall that is coaxial with the longitudinal axis of the capsule 2. The closing wall 23 is configured to close a mouth of a container. The side wall 24 is configured to couple with a neck of the container.

The capsule 2 comprises a tamper-evident band 25 joined to the side wall 24 by preferential detachment means suitable for making a capsule of tethered type and obtained by the aforesaid cutting device 1.

The preferential detachment means comprises a first horizontal notch 31 with several easy-to-break attachment points to define a weakening line, a second horizontal notch 32 spaced apart in a horizontal direction from the first horizontal notch 31 with the interposition of a first joint portion A, a third horizontal notch 33 spaced apart in a horizontal direction from the second horizontal notch with the interposition of a portion B that is not destined to be broken, a fourth horizontal notch 34 spaced apart in a horizontal direction from the third horizontal notch 33 with the interposition of a second joint portion C, a fifth horizontal notch 35 spaced apart in a vertical direction from the first horizontal notch 31, a sixth horizontal notch 36 spaced apart in a horizontal direction from the fifth horizontal notch 35 with the interposition of another portion D that is not destined to be broken, a seventh horizontal notch 37 spaced apart in a horizontal direction from the sixth horizontal notch 36 with the interposition of a third joint portion E.

The preferential detachment means comprises a first transverse notch 41 that joins the second horizontal notch 32 to the fifth horizontal notch 35, a second transverse notch 42 that joins the second horizontal notch 32 to the sixth horizontal notch 36, a third transverse notch 43 that joins the third horizontal notch 35 to the sixth horizontal notch 36, a fourth transverse notch 44 that joins the fourth horizontal notch 34 to the seventh horizontal notch 37.

The preferential detachment means comprises a fifth transverse notch 45 that on one side intersects the first horizontal notch 31 and on another side terminates with one end spaced apart in a horizontal direction from the fifth horizontal notch 35 with the interposition of a fourth joint portion F. The fifth transverse notch 45 intersects the first horizontal notch 31 in an intermediate point of the first horizontal notch 31.

The aforesaid end of the fifth transverse notch 45 is a blind end, i.e. such as to be completely surrounded by a portion of capsules that is not destined to be broken.

The tamper-evident band 25 is joined to the side wall 24 by a first connecting strap 51 defined between the first joint portion A and the fourth joint portion F and by a second connecting strap 52 defined between the second joint portion C and the third joint portion E.

It has been seen that advantages are obtained owing to the special conformation and arrangement of the fifth transverse notch 45, i.e. in which this transverse notch has one end that is arranged in an intermediate point of the first horizontal notch 31 and another end that bounds the fourth joint portion F and which is blind, i.e. ends entirely in a zone that is not destined to be broken (which means that the other end of the fifth transverse notch 45 that is contiguous with the fourth joint portion F is completely surrounded by material of the capsule that is not designed for breakage).

One encountered advantage is the significant flexibility of the second connecting strap 52 and thus its great resistance to breakage, which reduces the risk of undesired detachment of the tamper-evident band 25 from the rest of the capsule.

Further, it has been seen that the arrangement of the transverse notch 45, which is such as to form a sort of T-shaped notch at which the intersection with the first horizontal notch 31 means that the capsule 2, once the container has been opened to enable the user to consume the beverage contained therein, does not constitute an obstacle or an impediment to use, mainly owing to the fact that at least in the T-shaped notch zone no protrusion forms that can constitute an obstacle that is such as to make the operation of mixing or consuming the beverage difficult.

Another advantage is the great sturdiness of the tamper-evident band of the capsule, due probably to the fact that the total length of the notches made on the side wall of the capsule to make the tamper-proof band is relatively reduced, which improves the security of the capsule without degrading the ease of handling or reliability and the practicality of the tethered function.

It has also been established that the vertical, rather than oblique, arrangement of the fifth transverse notch 45 can further improve the aforesaid advantages, in particular by making the tethered connecting strap even sturdier.

1. Cutting device comprising a first set of horizontal blades, a second set of horizontal blades and a set of transverse blades; each horizontal blade of said first set of horizontal blades being spaced vertically from each horizontal blade of said second set of horizontal blades; said first set of horizontal blades comprising a first horizontal blade configured to make a horizontal cut with multiple easy-to-break attachment points to define a weakening line of a tamper-evident band of a container closure capsule, a second horizontal blade spaced horizontally from said first horizontal blade with the interposition of a first non-cutting zone, where “non-cutting zone” means an area configured to form a portion of the capsule not intended to break, a third horizontal blade spaced horizontally from said second horizontal blade with the interposition of a second non-cutting zone, and a fourth horizontal blade spaced horizontally from said third horizontal blade with the interposition of a third non-cutting zone; said second set of horizontal blades comprising a fifth horizontal blade, a sixth horizontal blade spaced horizontally from said fifth horizontal blade with the interposition of a fourth non-cutting zone, and a seventh horizontal blade spaced horizontally from said sixth horizontal blade with the interposition of a fifth non-cutting zone; said set of transverse blades comprising a first transverse blade joining said second horizontal blade with said fifth horizontal blade, a second transverse blade joining said second horizontal blade with said sixth horizontal blade, a third transverse blade joining said third horizontal blade with said sixth horizontal blade, a fourth transverse blade joining said fourth horizontal blade with said seventh horizontal blade, and a fifth transverse blade which is joined with said first horizontal blade and which ends with an end spaced in a horizontal direction from said fifth horizontal blade with the interposition of a sixth non-cutting zone;
wherein said fifth transverse blade is joined with said first horizontal blade at an intermediate point of said first horizontal blade so that a transverse notch made by said fifth transverse blade meets the horizontal notch made by said first horizontal blade at an intermediate point of said horizontal notch, and in that said end of said fifth transverse blade is free so that the transverse notch made by said fifth transverse blade ends with a blind end.

2. Cutting device according to claim 1, wherein the horizontal blades of said first set of horizontal blades have cutting edges that are coplanar with each other and/or wherein the horizontal blades of said second set of horizontal blades have cutting edges that are coplanar with each other.

3. Cutting device according to claim 1, wherein said end of said fifth transverse blade is located at a horizontal plane passing through a horizontal cutting edge of said fifth horizontal blade.

4. Cutting device according to claim 1, wherein at least one portion of said fifth horizontal blade is arranged in a vertical direction at a portion of said first horizontal blade and/or wherein at least one portion of said seventh horizontal blade is arranged in a vertical direction at a portion of said third horizontal blade.

5. Cutting device according to claim 1, wherein said fifth transverse blade is vertical.

6. Cutting device according to claim 1, wherein said fifth transverse blade comprises a cutting element provided at one end with a transverse cutting edge, said cutting element being inserted into a seat of said cutting device and being coupled with an interchangeable gauge block to determine a length between said transverse cutting edge and an abutment face of said gauge block, said abutment face being arranged against a bottom wall of said seat, one end of said cutting element opposite said transverse cutting edge being spaced from said bottom wall.

7. Cutting device according to claim 6, comprising a set of two or more interchangeable gauge blocks selectively matable with said cutting element to selectively determine two or more different lengths measured between said transverse cutting edge and an abutment face of the respective gauge block.

8. Cutting device according to claim 1, wherein said first transverse blade is oblique and/or wherein said second transverse blade is oblique and/or wherein said third transverse blade is oblique and/or wherein said fourth transverse blade is oblique.

9. Cutting device according to claim 1, wherein at least one of said second horizontal blade, third horizontal blade and fourth horizontal blade is configured to perform a horizontal cut with at least one easy-to-break attachment point.

10. Cutting device according to claim 1, wherein at least one of said fifth horizontal blade, sixth horizontal blade and seventh horizontal blade is configured to perform a horizontal cut with at least one easy-to-break attachment point.

11. Cutting device according to claim 1, wherein said fifth transverse blade comprises a continuous transverse cutting edge configured to perform a transverse notch without any easy-to-break attachment point.

12. Cutting device according to claim 11, wherein said continuous transverse cutting edge comprises a vertical cutting edge.

13. Cutting device according to claim 1, wherein said first horizontal blade terminates with a proximal end which is close to said second horizontal blade and which is contiguous to said first non-cutting zone, and wherein said first horizontal blade has a continuous horizontal cutting edge section extending between said proximal end and said intermediate point, said continuous horizontal cutting edge section being configured to perform a continuous horizontal cutting section without any easy-to-break attachment point.

14. Cutting device according to claim 1, comprising a layered structure with at least three plates which are fixed in a pack on top of each other and which comprise a first plate which carries said first set of horizontal blades, a second plate which carries said second set of horizontal blades and a third plate which carries said set of transverse blades and which is interposed between said first plate and second plate.

15. Cutting device according to claim 1, wherein said first set of horizontal blades, said second set of horizontal blades and at least said first, second, third and fourth transverse blades are integrated in a single piece, and wherein said fifth transverse blade is integrated in said single piece.

16. Cutting device according to claim 6, wherein said first set of horizontal blades, said second set of horizontal blades and at least said first, second, third and fourth transverse blades are integrated in a single piece.

17. Cutting device according to claim 1, wherein at least one of said first, second, third and fourth transverse blades is joined to at least one of said horizontal blades by means of a rounded cutting-edge section.

18. Cutting device according to claim 17, wherein said first transverse blade is joined to said second horizontal blade by means of a rounded cutting edge section and/or said first transverse blade is joined to said fifth horizontal blade by means of a rounded cutting edge section and/or said second transverse blade is joined to said second horizontal blade by means of a rounded cutting edge section and/or said second transverse blade is joined to said sixth horizontal blade by means of a rounded cutting edge section and/or said third transverse blade is joined to said third horizontal blade by means of a rounded cutting edge section and/or said third transverse blade is joined to said sixth horizontal blade by means of a rounded cutting edge section and/or said fourth transverse blade is joined to said fourth horizontal blade by means of a rounded cutting edge section and/or said fourth transverse blade is joined to the said seventh horizontal blade by means of a rounded cutting edge section.

19. Cutting apparatus comprising a feed path traversable by a capsule, a cutting zone arranged in said feed path, a carousel equipped with a plurality of transport units each of which is configured to engage with a respective capsule and transport the capsule along said feed path, and a cutting device arranged in said cutting zone to cut the capsule, said cutting device being made according to claim 1.

20. A “tethered” capsule for closing a container, said capsule comprising a closing wall configured to close a mouth of a container, a side wall configured to mate with a neck of the container and provided with an end joined to a periphery of said closing wall, and a tamper-evident band joined to said side wall by preferential detachment means; said preferential detachment means comprising a first horizontal notch with multiple attachment points for easy breakage to define a weakening line, a second horizontal notch spaced in a horizontal direction from said first horizontal notch with the interposition of a first joint portion, a third horizontal notch spaced in a horizontal direction from said second horizontal notch with the interposition of a portion not intended for breakage, a fourth horizontal notch spaced in a horizontal direction from said third horizontal notch with the interposition of a second joint portion, a fifth horizontal notch spaced in a vertical direction from said first horizontal notch, a sixth horizontal notch spaced in a horizontal direction from said fifth horizontal notch with the interposition of another portion not intended for breakage, a seventh horizontal notch spaced in a horizontal direction from said sixth horizontal notch with the interposition of a third joint portion, a first transverse notch which joins said second horizontal notch and said fifth horizontal notch, a second transverse notch which joins said second horizontal notch and said sixth horizontal notch, a third transverse notch which joins said third horizontal notch and said sixth horizontal notch, a fourth transverse notch which joins said fourth horizontal notch and said seventh horizontal notch, and a fifth transverse notch which on one side intersects said first horizontal notch and on another side ends with an extremity spaced in a horizontal direction from said fifth horizontal notch with the interposition of a fourth joint portion; said fifth transverse notch intersecting said first horizontal notch at an intermediate point of said first horizontal notch; said end of said fifth transverse notch being a blind end; said tamper-evident band being joined to said side wall by a first connecting strap defined between said first joint portion and said fourth joint portion and by a second connecting strap defined between said second joint portion and said third joint portion.
